(19) United States
(12) Patent Application Publication
(10) Pub. No.: US 2025/0303864 A1
(43) Pub. Date: Oct. 2, 2025

(54) DRIVING ASSISTANCE APPARATUS AND VEHICLE

(71) Applicant: SUBARU CORPORATION, Tokyo (JP)

(72) Inventors: Kou SASAKI, Tokyo (JP); Yasuhiro TAGUCHI, Tokyo (JP); Yuta TAKENOYA, Tokyo (JP); Yoshikatsu NISHIYAMA, Tokyo (JP); Tomomi TAKATA, Tokyo (JP)

(73) Assignee: SUBARU CORPORATION, Tokyo (JP)

(21) Appl. No.: 19/077,360

(22) Filed: Mar. 12, 2025

(30) Foreign Application Priority Data
Mar. 29, 2024 (JP) 2024-055652

(51) Int. Cl. B60K 35/28; B60W 50/10; G09B 9/042

(52) U.S. Cl. CPC B60K 35/28; B60W 50/10; G09B 9/042; B60K 2360/161; B60K 2360/165

(57) ABSTRACT

A driver assistance apparatus includes a processor and a communicator. The processor is configured to generate request data regarding a request of a user for an input, and process response data to the request data. The communicator is configured to transmit the request data to a user interface, and receive the response data from the user interface. The processor is configured to, upon acquisition of data regarding refusal of use of an unused driver assistance system as the response data, generate data regarding a proposal for coaching in the driver assistance system as the request data, and upon acquisition of data regarding consent to the coaching in the driver assistance system as the response data, perform processing necessary for the coaching in line with the input of an intention of the user.

### CROSS-REFERENCE TO RELATED APPLICATIONS

The present application claims priority from Japanese Patent Application No. 2024-055652 filed on Mar. 29, 2024, the entire contents of which are hereby incorporated by reference.

### BACKGROUND

The disclosure relates to a driver assistance apparatus and a vehicle.

In recent years, research and development of various driver assistance systems have been made, aiming at reduction in burdens on drivers and avoidance of incidents. Examples of driver assistance systems include a preceding vehicle tracking system, a lane keeping system, and an automated driving system.

Because these driver assistance systems are convenient and useful for drivers, a proposal for use of these driver assistance systems is made to drivers, through a human machine interface (HMI). For example, Japanese Unexamined Patent Application Publication (JP-A) Nos. 2017-199187 and 2003-252130 include description that a proposal for driver assistance systems is made through an HMI.

### SUMMARY

An aspect of the disclosure provides a driver assistance apparatus including a processor and a communicator. The processor is configured to generate request data regarding a request of a user for an input, and process response data to the request data. The communicator is configured to transmit the request data to a user interface, and receive the response data from the user interface. The processor is configured to perform the following (A1) and (A2).
(A1) Upon acquisition of data regarding refusal of use of an unused driver assistance system as the response data, generating data regarding a proposal for coaching in the driver assistance system as the request data
(A2) Upon acquisition of data regarding consent to the coaching in the driver assistance system as the response data, performing processing necessary for the coaching in line with the input of an intention of the user

An aspect of the disclosure provides a vehicle including a processor and a communicator. The processor is configured to generate request data regarding a request of a user for an input, and process response data to the request data. The communicator is configured to transmit the request data to a user interface, and receive the response data from the user interface. The processor is configured to perform the following (B1) and (B2).
(B1) Upon acquisition of data regarding refusal of use of an unused driver assistance system as the response data, generating data regarding a proposal for coaching in the driver assistance system as the request data
(B2) Upon acquisition of data regarding consent to the coaching in the driver assistance system as the response data, performing processing necessary for the coaching in line with the input of an intention of the user

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram of an example of a vehicle according to an embodiment of the disclosure.

FIG. 2 illustrates an example of an HMI in FIG. 1.

FIG. 3 is a flowchart of an example of a procedure of promoting use of an unused driver assistance system in the vehicle in FIG. 1.

FIG. 4 is a flowchart of an example of a processing procedure necessary for coaching in the unused driver assistance system in step S107 in FIG. 3.

FIG. 5 is a block diagram of an example of a vehicle according to an embodiment of the disclosure.

FIG. 6 is a flowchart of an example of a processing procedure necessary for coaching in an unused driver assistance system in the embodiment.

FIG. 7 is a block diagram of an example of a vehicle according to an embodiment of the disclosure.

FIG. 8 is a flowchart of an example of a processing procedure necessary for coaching in an unused driver assistance system in the embodiment.

### DETAILED DESCRIPTION

In recent years, research and development of various driver assistance systems have been made, aiming at reduction in burdens on drivers and avoidance of incidents. Examples of driver assistance systems include a preceding vehicle tracking system, a lane keeping system, and an automated driving system.

Because these driver assistance systems are convenient and useful for drivers, a proposal for use of these driver assistance systems is made to drivers, through a human machine interface (HMI). For example, JP-A Nos. 2017-199187 and 2003-252130 include description that a proposal for driver assistance systems is made through an HMI.

In the invention described in JP-A No. 2017-199187, when the number of times of refusal of a determined package of driver assistance is smaller than a predetermined threshold value, the determined package of driver assistance is continuously proposed to a driver. When the number of times of the refusal of the determined package of driver assistance is equal to or larger than the predetermined threshold value, a different package of driver assistance from the determined package of driver assistance is newly proposed. However, JP-A No. 2017-199187 does not include any disclose or suggestion about how to get the driver to use the determined package of driver assistance.

In the invention described in JP-A No. 2003-252130, an instruction about setting of automatic cruising is given by a driver with an HMI. However, JP-A No. 2003-252130 does not include any disclosure or suggestion about how to get the driver to use the automatic cruising when the setting of the automatic cruising is refused by the driver.

As described, existing techniques do not include any disclosure or suggestion about how to get a driver to use a function which the driver has refused to use. It is desirable to provide a driver assistance apparatus and a vehicle that make it possible to promote use of an unused driver assistance system.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

Description is given next of a vehicle 100 according to a first embodiment of the disclosure. FIG. 1 is a block diagram of an example the vehicle 100 of the first embodiment of the disclosure. As illustrated in FIG. 1, the vehicle 100 may include, for example, a travel_ECU 110, a GNSS sensor 120, a speed sensor 130, a roadmap DB 140, a CP_ECU 150, a human machine interface (HMI) 160, and a communicator 170.

The vehicle 100 is configured to communicate with a terminal device 200 through a communication network. The terminal device 200 is configured to communicate with the vehicle 100 through the communication network. The communication network may include, for example, the Internet, a cloud network, or a company-specific network. The travel_ECU 110, the GNSS sensor 120, the speed sensor 130, the roadmap DB 140, the CP_ECU 150, and the communicator 170 may be coupled through an in-vehicle communication line such as a CAN (Controller Area Network).

The travel_ECU 110 is configured to control the vehicle 100 in accordance with, for example, a driving mode. Non-limiting examples of the driving mode may include a travel control mode. The travel control mode is a driving mode including assisting the driver of the vehicle 100 in making driving operations to enhance safety of pedestrians, vehicles, etc. around the vehicle 100 (subject vehicle). Non-limiting examples of the travel control mode may include a preceding vehicle tracking mode, a lane keeping mode, an automated driving mode, etc. In one embodiment of the disclosure, the preceding vehicle tracking mode, the lane keeping mode, the automated driving mode, etc. may serve as a “driver assistance system”.

In one embodiment of the disclosure, a module including the travel_ECU 110 and the CP_ECU 150 may serve as a “driver assistance apparatus”. In one embodiment of the disclosure, the travel_ECU 110 may serve as a “processor”. In one embodiment of the disclosure, the CP_ECU 150 may serve as a “communicator”.

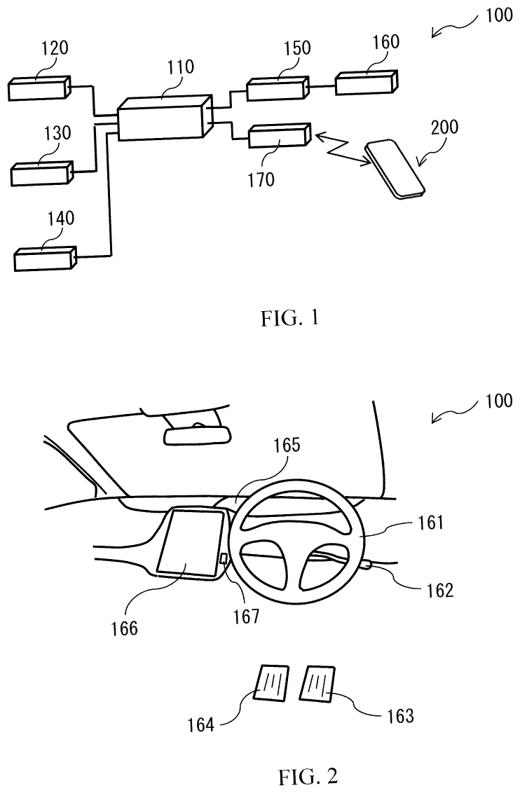

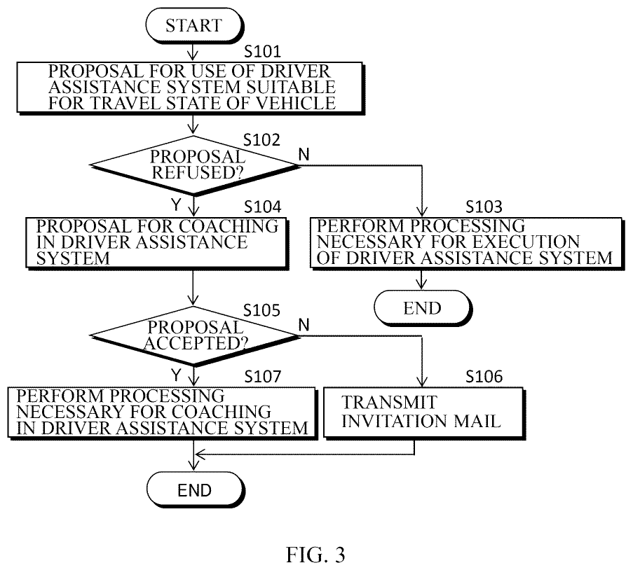

The HMI 160 may be coupled to the CP_ECU 150. As illustrated in FIG. 2, the HMI 160 may include, for example, a steering wheel 161, a switch 162, an accelerator pedal 163, a brake pedal 164, a meter panel display 165, a center panel display 166, a speaker 167, etc. The switch 162 may include, for example, a switch configured to control lighting of a right turn signal lamp or a left turn signal lamp. The meter panel display 165 may include, for example, a liquid crystal display panel or an organic EL (electroluminescence) display panel. The meter panel display 165 is configured to display, for example, information such as a speed and an engine speed. The center panel display 166 may include, for example, a liquid crystal display panel or an organic EL display panel that accepts an input on a touchscreen. The center panel display 166 is configured to accept various settings including, for example, setting of the driving mode.

The CP_ECU 150 is configured to appropriately notify, upon receiving a control signal from the travel_ECU 110, the driver of the vehicle 100 of various kinds of information by display, sound, etc. through the HMI 160. The various kinds of information may include, for example, various warnings for a preceding vehicle, etc., a situation about how a driver assistance control is being carried out, and travel environment of the vehicle 100. The CP_ECU 150 is configured to output, to the travel_ECU 110, various kinds of information inputted by driver of the vehicle 100 through the HMI 160.

The GNSS sensor 120 is configured to receive positioning signals transmitted from positioning satellites. The speed sensor 130 is cofigured to detect the speed of the vehicle 100. The roadmap DB 140 may include a high-precision roadmap database. The high-precision roadmap database may include a large-capacity storage medium such as an HDD (Hard Disk Drive), and hold high-precision roadmap data, or a dynamic map. The high-precision roadmap data may include, for example, road data and traffic data.

The communicator 170 may include a communication interface configured to communicate with the terminal device 200 of the driver of the vehicle 100. The communicator 170 is configured to transmit data obtained from the travel_ECU 110 to the terminal device 200 through the communication network. The terminal device 200 is configured to transmit data obtained by the terminal device 200 to the vehicle 100, that is, the communicator 170, through the communication network.

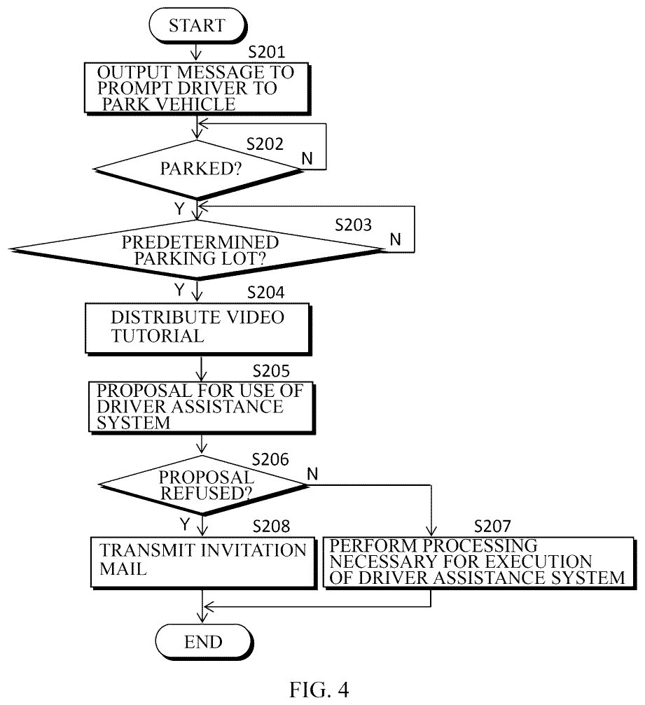

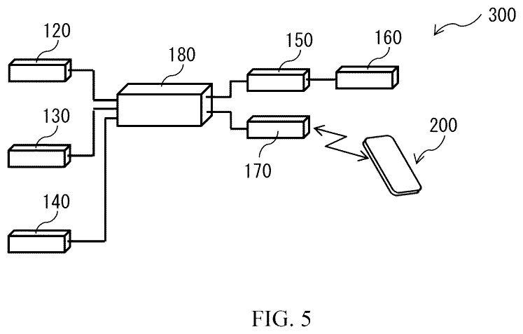

Description is given next, with reference to FIGS. 3 and 4, of promotion of use of an unused driver assistance system in the vehicle 100. FIG. 3 illustrates an example of a procedure of promoting the use of the unused driver assistance system in the vehicle 100. FIG. 4 illustrates an example of a processing procedure necessary for coaching in the unused driver assistance system in step S107 in FIG. 3.

Let us assume that the vehicle 100 is traveling on a certain road. At this occasion, the travel_ECU 110 may generate a proposal (hereinafter referred to as a “proposal α1”) for the driver assistance system in line with a travel state of the vehicle 100 based on the various kinds of data obtained from the GNSS sensor 120, the speed sensor 130, the roadmap DB 140, and the CP_ECU 150 during travel. The travel_ECU 110 may output the proposal α1 to the CP_ECU150.

The proposal α1 is a proposal for one driver assistance system suitable for the travel state of the vehicle 100, out of the driver assistance systems prepared in the vehicle 100. The driver assistance system proposed in the proposal α1 is an unused driver assistance system for the vehicle 100 or the driver. The travel_ECU 110 may generate, for the driver, a proposal for use of the unused driver assistance system suitable for the travel state of the vehicle 100 (step S101). In one embodiment of the disclosure, the proposal α1 may serve as “request data regarding a request of a user for an input”.

For example, when a preceding vehicle is present ahead of the vehicle 100, the travel_ECU 110 may generate a proposal for use of the preceding vehicle tracking mode as the proposal α1. For example, when the vehicle 100 is traveling on a road including a continuous gradual curve, the travel_ECU 110 may generate a proposal for use of the lane keeping mode as the proposal α1. For example, when the vehicle 100 is traveling on an expressway, the travel_ECU 110 may generate a proposal for use of the automated driving mode as the proposal α1.

The CP_ECU 150 may output a video signal including the proposal α1 acquired from the travel_ECU 110 to the center panel display 166, and output an audio signal corresponding to the proposal α1 to the speaker 167. The center panel display 166 may display a video including the proposal α1, and the speaker 167 may output a sound corresponding to the proposal α1 while the video including the proposal α1 is being displayed on the center panel display 166.

The driver inputs a response β1 to the proposal α1 from the vehicle 100 through the HMI 160. The response β1 may be data indicating acceptance of the proposal α1 or data indicating refusal of the proposal α1, i.e., data regarding refusal of use. In one embodiment of the disclosure, the response β1 may serve as “response data to the request data”. The driver inputs the response β1 by, for example, operating the center panel display 166. When the response β1 is inputted, the center panel display 166 may output the inputted response β1 to the CP_ECU 150. When the response β1 is inputted, the CP_ECU 150 may output the inputted response β1 to the travel_ECU 110.

The travel_ECU 110 may determine whether the response β1 is the refusal of the proposal α1 (step S102). When the response β1 is the acceptance of the proposal α1 (step S102; N), the travel_ECU 110 may perform processing necessary for execution of the driver assistance system corresponding to the proposal α1 (step S103). The travel_ECU 110 may select, for example, the preceding vehicle tracking mode, the lane keeping mode, or the automated driving mode as the driving mode, and perform processing corresponding to the selected driving mode.

When the response β1 is refusal of the proposal α1, i.e., data regarding refusal of use (step S102: Y), the travel_ECU 110 may generate a proposal for coaching in the refused driver assistance system (hereinafter, referred to as “proposal α2”), and output the proposal α2 to the CP_ECU 150. In one embodiment of the disclosure, the proposal α2 may serve as “request data regarding a request of a user for an input” and “data regarding a proposal for coaching”.

The CP_ECU 150 may output a video signal including the proposal α2 acquired from the travel_ECU 110 to the center panel display 166, and output an audio signal corresponding to the proposal α2 to the speaker 167. The center panel display 166 may display a video including the proposal α2, and the speaker 167 may output a sound corresponding to the proposal α2 while the video including the proposal α2 is displayed on the center panel display 166.

The driver may input, through the HMI 160, a response β2 to the proposal α2 by the vehicle 100. The response β2 is data indicating acceptance of the proposal α2, i.e., data regarding consent to the coaching, or data indicating refusal of the proposal α2, i.e., data regarding refusal of the coaching. In one embodiment of the disclosure, the response β2 may serve as “response data to the request data”, “data regarding consent to the coaching”, and “data regarding refusal of the coaching”. The driver may input the response β2 by, for example, operating the center panel display 166. When the response β2 is inputted, the center panel display 166 may output the inputted response β2 to the CP_ECU 150. When the response β2 is inputted, the CP_ECU 150 may output the inputted response β2 to the travel_ECU 110.

The travel_ECU 110 may determine whether the response β2 is the acceptance of the proposal α2 (step S105). When the response β2 is the refusal of the proposal α2, i.e., data regarding refusal of the coaching (step S105; N), the travel_ECU 110 may perform processing necessary for transmission, to the terminal device 200, of an invitation mail to the proposal α2, i.e., coaching in the driver assistance system, or an invitation mail to a trial session of the driver assistance system at a dealer (step S106).

When the response β2 is the acceptance of the proposal α2, i.e., data regarding consent to the coaching (step S105; Y), the travel_ECU 110 may perform processing necessary for the accepted coaching in the driver assistance system (step S107).

For example, first, the travel_ECU 110 may generate a message prompting the driver to park the vehicle 100 and output the message to the CP_ECU 150 to ensure safety of the vehicle 100 when performing the coaching (step S201). The CP_ECU 150 may output a video signal including the message acquired from the travel_ECU 110 to the center panel display 166 and output an audio signal corresponding to the message to the speaker 167. The center panel display 166 may display a video including the message, and the speaker 167 may output a sound corresponding to the message while the video including the message is displayed on the center panel display 166.

Thereafter, the travel_ECU 110 may monitor an input of a signal indicating that parking of the vehicle 100 has been detected, and continue to determine whether the vehicle 100 has been parked (step S202). At this occasion, let us assume that the driver has parked the vehicle 100 in accordance with the message from the vehicle 100. When the travel_ECU 110 acquires, from the vehicle speed sensor 130, a signal indicating that the speed (vehicle speed) of the vehicle 100 has become zero from a value other than zero, the travel_ECU 110 may determine that the parking of the vehicle 100 has been detected (step S202; Y). Upon sequential acquisition of a vehicle travel signal and a vehicle parking signal in this order from the vehicle speed sensor 130, the travel_ECU 110 may determine that the parking of the vehicle 100 has been detected. The vehicle travel signal is a signal other than the speed of zero. The vehicle parking signal is a signal of the speed of zero. The travel_ECU 110 may determine whether the vehicle 100 has been parked, using, for example, a parking signal of a parking brake in place of, or together with, a signal of the speed (vehicle speed) of the vehicle 100. At this occasion, the parking signal of the parking brake may serve as the vehicle parking signal. The parking signal of the parking brake is acquirable by, for example, a sensor configured to detect a state of the parking brake.

The travel_ECU 110 may further determine whether the vehicle 100 has been parked in a predetermined parking lot, based on the signal obtained from the GNSS sensor 120 and the map data obtained from the roadmap DB 140 (step S203). When the vehicle 100 has been parked in the predetermined parking lot (step S203; Y), the travel_ECU 110 may determine that the acquisition of the signal indicating that the vehicle 100 has been parked in the predetermined parking lot is a request for a start of the proposal α2 (coaching in the driver assistance system) as the intention of the user, and perform the processing necessary for execution of the proposal α2. In one example, the travel_ECU 110 may read a video tutorial on the driver assistance system from a storage of the vehicle 100 or a data server on a network, and transmit, or distribute, the video tutorial to the terminal device 200 through the communicator 170 (step S204). The terminal device 200 may play back the video tutorial transmitted, or distributed, from the vehicle 100, or the communicator 170. It is possible for the driver to learn the driver assistance system with the video tutorial played back by the terminal device 200.

The travel_ECU 110 may output the video tutorial on the driver assistance system to the CP_ECU 150. In this case, the CP_ECU 150 may output the video tutorial obtained from the travel_ECU 110 to the center panel display 166. The center panel display 166 may play back the video tutorial, and the speaker 167 may output a sound corresponding to the video tutorial displayed on the center panel display 166.

At an end of the transmission, or the distribution, of the video tutorial or at an end of the playback of the video tutorial by the terminal device 200, the travel_ECU 110 may generate again the proposal (proposal α1) for the use of the driver assistance system and output the proposal α1 to the CP_ECU 150 (step S205).

The CP_ECU 150 may output a video signal including the proposal α1 acquired from the travel_ECU 110, to the center panel display 166, and output an audio signal corresponding to the proposal α1 to the speaker 167. The center panel display 166 may display the video including the proposal α1, and the speaker 167 may output the sound corresponding to the proposal α1 while the video including the proposal α1 is displayed on the center panel display 166.

The driver may input, through the HMI 160, the response β1 to the proposal α1 by the vehicle 100. The driver may input the response β1 by, for example, operating the center panel display 166. When the response β1 is inputted, the center panel display 166 may output the inputted response β1 to the CP_ECU 150. When the response β1 is inputted, the CP_ECU 150 may output the inputted response β1 to the travel_ECU 110.

The travel_ECU 110 may determine whether the response β1 is the refusal of the proposal α1 (step S206). When the response β1 is the acceptance of the proposal α1 (step S206; N), the travel_ECU 110 may perform the processing necessary for the execution of the driver assistance system corresponding to the proposal α1 (step S207). The travel_ECU 110 may select, for example, the preceding vehicle tracking mode, the lane keeping mode, or the automated driving mode as the driving mode, and perform the processing corresponding to the selected driving mode.

When the response β1 is the refusal of the proposal α1 (step S206; Y), the travel_ECU 110 may perform the processing necessary for transmission, to the terminal device 200, of the invitation mail to the trial session of the refused driver assistance system at the dealer (step S208). In this way, the use of the unused driver assistance system is promoted.

Next, effects of the vehicle 100 according to the first embodiment of the disclosure are described.

In the embodiment, upon the acquisition of the refusal of the proposal for the use of the driver assistance system as the response, the proposal for the coaching in the driver assistance system is made. Upon the acquisition of the consent to the coaching in the driver assistance system as the response, the processing necessary for the coaching is performed in line with the input of the intention of the user. Hence, it is possible to promote the use of the unused driver assistance system.

In the embodiment, upon the acquisition of the signal indicating that the vehicle 100 has been parked in the predetermined parking lot, the acquisition of such a signal may be determined as the request for the start of the coaching in the driver assistance system as the intention of the user, and the processing necessary for execution of the coaching in the driver assistance system may be performed. Hence, it is possible to promote the use of the unused driver assistance system while securing the safety of the vehicle 100.

In the embodiment, when the response β2 is the acceptance of the proposal α2, the travel_ECU 110 may determine that the response β2 is the request for the start of the coaching in the driver assistance system as the intention of the user, and perform the processing necessary for the execution of the coaching in the driver assistance system. In such a case as well, it is possible to promote the use of the unused driver assistance system.

In the embodiment, the processing necessary for the distribution of the video for the coaching, or the video tutorial, to the center panel display 166 or the terminal device 200 may be performed. Thus, it is possible for the driver to learn the unused driver assistance system with the video for the coaching, or the video tutorial.

In the embodiment, the message prompting the driver to park the vehicle 100 in the predetermined parking lot may be generated. Whether the vehicle 100 has been parked in the predetermined parking lot may be monitored based on the signal obtained from the GNSS sensor 120 and the map data obtained from the roadmap DB 140. Hence, it is possible to promote the use of the unused driver assistance system while securing the safety of the vehicle 100.

In the embodiment, when the proposal α2 (coaching in the driver assistance system) is refused, the processing necessary for the transmission, to the terminal device 200, of the invitation mail to the proposal α2 or the invitation mail to the trial session of the driver assistance system at the dealer may be performed. Continuously transmitting such an invitation mail makes it possible to encourage the driver to be interested in using the unused driver assistance system some time.

Next, a vehicle 300 according to a second embodiment of the disclosure is described. FIG. 5 is a block diagram of an example of the vehicle 300 according to the second embodiment of the disclosure. As illustrated in FIG. 5, the vehicle 300 may include, for example, a travel_ECU 180, the GNSS sensor 120, the speed sensor 130, the roadmap DB 140, the CP_ECU 150, the HMI 160, and the communicator 170.

The travel_ECU 180 is configured to control the vehicle 300 in accordance with, for example, the driving mode. Non-limiting examples of the driving mode may include the travel control mode and a simulation mode. The travel control mode is a driving mode including assisting the driver of the vehicle 300 in making driving operations to enhance safety of pedestrians, vehicles, etc. around the vehicle 300 (subject vehicle). Non-limiting examples of the travel control mode may include the preceding vehicle tracking mode, the lane keeping mode, the automated driving mode, etc. The simulation mode is a mode including assisting the driver of the vehicle 300 to promote the use of the travel control mode. Non-limiting examples of the simulation mode may include a video simulation mode. Contents of processing in the video simulation mode are described later in detail.

In one embodiment of the disclosure, a module including the travel_ECU 180 and the CP_ECU 150 may serve as a “driver assistance apparatus”. In one embodiment of the disclosure, the travel_ECU 180 may serve as a “processor”. In one embodiment of the disclosure, the CP_ECU 150 may serve as a “communicator”.

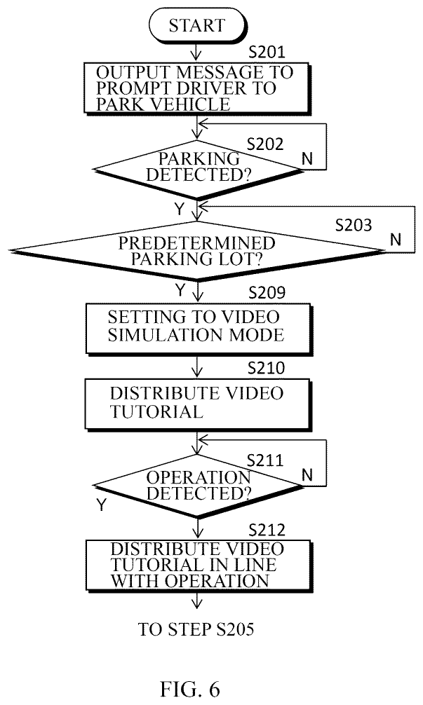

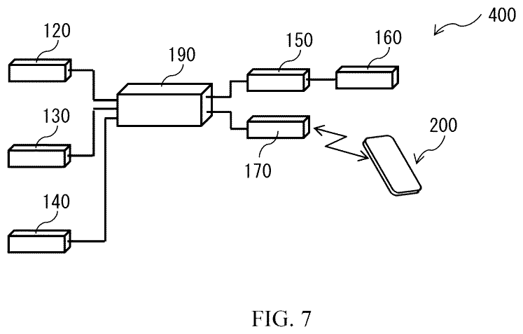

Next, with reference to FIG. 6, the promotion of the use of the unused driver assistance system in the vehicle 300 is described. FIG. 6 illustrates an example of a processing procedure necessary for the coaching in the unused driver assistance system in step S107 in FIG. 3. In the following, each step illustrated in FIG. 6 is described.

For example, first, the travel_ECU 180 may generate the message prompting the driver to park the vehicle 300 and output the message to the CP_ECU150, to ensure the safety of the vehicle 300 when performing the coaching (step S201). The CP_ECU 150 may output a video signal including the message acquired from the travel_ECU 180 to the center panel display 166 and output an audio signal corresponding to the message to the speaker 167. The center panel display 166 may display a video including the message, and the speaker 167 may output the sound corresponding to the message while the video including the message is displayed on the center panel display 166.

Thereafter, the travel_ECU 180 may monitor an input of a signal indicating that parking of the vehicle 300 has been detected, and continue to determine whether the vehicle 300 has been parked (step S202). At this occasion, let us assume that the driver has parked the vehicle 300 in accordance with the message from the vehicle 300. When the travel_ECU 180 acquires, from the vehicle speed sensor 130, a signal indicating that the speed (vehicle speed) of the vehicle 300 has become zero, the travel_ECU 180 may determine that the parking of the vehicle 300 has been detected (step S202; Y).

The travel_ECU 180 may further determine whether the vehicle 300 has been parked in the predetermined parking lot, based on the signal obtained from the GNSS sensor 120 and the map data obtained from the roadmap DB 140 (step S203). When the vehicle 300 has been parked in the predetermined parking lot (step S203; Y), the travel_ECU 180 may determine that the acquisition of the signal indicating that the vehicle 300 has been parked in the predetermined parking lot is the request for the start of the proposal α2 (coaching in the driver assistance system) as the intention of the user, and perform the processing necessary for the execution of the proposal α2.

In one example, first, the travel_ECU 180 may set the video simulation mode as the driving mode (step S209). This makes it possible for the travel_ECU 180 to reflect the driver's operations of the HMI 160 not in actual travel of the vehicle 300 but in the video tutorial described later. That is, for example, the driver's operations of the switch 162, the accelerator pedal 163, or the like exert no influence on the travel of the vehicle 300.

Thereafter, the travel_ECU 180 may read the video tutorial on the driver assistance system from a storage of the vehicle 300 or a data server on a network, and transmit, or distribute, the video tutorial to the terminal device 200 through the communicator 170 (step S210). The terminal device 200 may play back the video tutorial transmitted, or distributed, from the vehicle 300, or the communicator 170. It is possible for the driver to learn the unused driver assistance system with the video tutorial played back by the terminal device 200.

The travel_ECU 180 may output the video tutorial on the driver assistance system to the CP_ECU 150. In this case, the CP_ECU 150 may output the video tutorial obtained from the travel_ECU 180 to the center panel display 166. The center panel display 166 may play back the video tutorial, and the speaker 167 may output the sound corresponding to the video tutorial displayed on the center panel display 166.

The travel_ECU 180 may monitor an input of a signal (operation signal) indicating detection of an operation of the HMI 160 necessary for the use of the driver assistance system, and continue to determine presence or absence of an operation of the HMI 160 necessary for the use of the driver assistance system (step S211). At this occasion, let us assume that the driver has made an operation of the HMI 160 necessary for the use of the driver assistance system in accordance with the message included in the video tutorial. When the travel_ECU 180 acquires a signal indicating the detection of the operation of the HMI 160 (step S211; Y), the travel_ECU 180 may generate the video tutorial including a response to the detected operation, and perform processing necessary for transmission, or distribution, of the generated video tutorial (step S212).

The travel_ECU 180 may transmit, or distribute, the video tutorial including the response to the detected operation, to the terminal device 200 through the communicator 170. The terminal device 200 may play back the video tutorial transmitted, or distributed, from the vehicle 300, or the communicator 170. The travel_ECU 180 may output the video tutorial including the response to the detected operation, to the CP_ECU 150. In this case, the CP_ECU 150 may output the video tutorial obtained from the travel_ECU 180 to the center panel display 166. The center panel display 166 may play back the video tutorial, and the speaker 167 may output the sound corresponding to the video tutorial displayed on the center panel display 166. It is possible for the driver to try using the driving assistance system with the video tutorial played back by the terminal device 200 or on the center panel display 166.

At an end of the transmission, or the distribution, of the video tutorial or at an end of the playback of the video tutorial by the terminal device 200, the travel_ECU 180 may perform steps S205 to S208 described above. In this way, the use of the unused driver assistance system is promoted.

Next, effects of the vehicle 300 according to the second embodiment of the disclosure are described.

In the embodiment, upon the acquisition of the refusal of the proposal for the use of the driver assistance system as the response, the proposal for the coaching in the driver assistance system is made. Upon the acquisition of the consent to the proposal for the coaching in the driver assistance system as the response, the processing necessary for the coaching is performed in line with the input of the intention of the user. Hence, it is possible to promote the use of the unused driver assistance system.

In the embodiment, upon the acquisition of the signal indicating that the vehicle 300 has been parked in the predetermined parking lot, the acquisition of such a signal may be determined as the request for the start of the coaching in the driver assistance system as the intention of the user, and the processing necessary for the execution of the coaching in the driver assistance system may be performed. Hence, it is possible to promote the use of the unused driver assistance system while securing the safety of the vehicle 300.

In the embodiment, when the response β2 is the acceptance of the proposal α2, the travel_ECU 180 may determine that the response β2 is the request for the start of the coaching in the driver assistance system as the intention of the user, and perform the processing necessary for the execution of the coaching in the driver assistance system. In such a case as well, it is possible to promote the use of the unused driver assistance system.

In the embodiment, the processing necessary for the distribution of the video for the coaching, or the video tutorial, to the center panel display 166 or the terminal device 200 may be performed. Thus, it is possible for the driver to learn the unused driver assistance system with the video for the coaching, or the video tutorial.

In the embodiment, as the processing necessary for the coaching, when the vehicle 300 is set to the video simulation mode and the signal indicating the detection of the operation of the HMI 160 necessary for the use of the driver assistance system is acquired, the processing necessary for the distribution of the video, or the video tutorial, including the response to the detected operation is performed. Hence, it is possible for the driver to try using the unused driver assistance system with the video tutorial played back by the terminal device 200 or on the center panel display 166.

In the embodiment, the message prompting the driver to park the vehicle 300 in the predetermined parking lot may be generated. Whether the vehicle 300 has been parked in the predetermined parking lot may be monitored based on the signal obtained from the GNSS sensor 120 and the map data obtained from the roadmap DB 140. Hence, it is possible to promote the use of the unused driver assistance system while securing the safety of the vehicle 300.

In the embodiment, when the proposal α2 (coaching in the driver assistance system) is refused, the processing necessary for the transmission, to the terminal device 200, of the invitation mail to the proposal α2 or the invitation mail to the trial session of the driver assistance system at the dealer may be performed. Continuously transmitting such an invitation mail makes it possible to encourage the driver to be interested in using the unused driver assistance system some time.

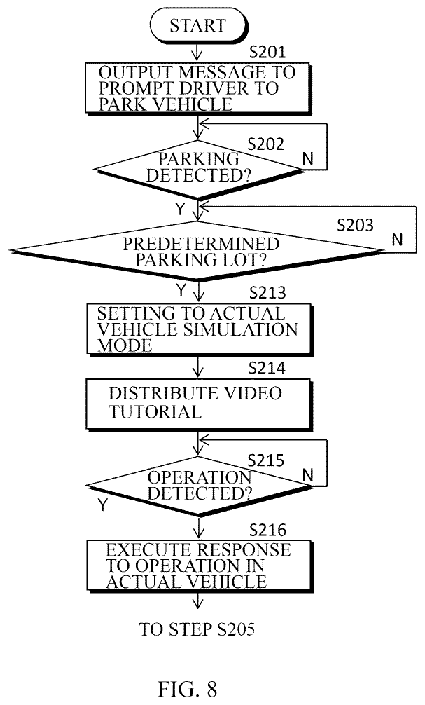

Next, a vehicle 400 according to a third embodiment of the disclosure is described. FIG. 7 is a block diagram of an example of the vehicle 400 according to the third embodiment of the disclosure. As illustrated in FIG. 7, the vehicle 400 may include, for example, a travel_ECU 190, the GNSS sensor 120, the speed sensor 130, the roadmap DB 140, the CP_ECU 150, the HMI 160, and the communicator 170.

The travel_ECU 190 is configured to control the vehicle 400 in accordance with, for example, the driving mode. Non-limiting examples of the driving mode may include the travel control mode and the simulation mode. The travel control mode is the driving mode including assisting the driver of the vehicle 400 in making the driving operations to enhance the safety of pedestrians, vehicles, etc. around the vehicle 400 (subject vehicle). Non-limiting examples of the travel control mode may include the preceding vehicle tracking mode, the lane keeping mode, the automated driving mode, etc. The simulation mode is the mode including assisting the driver of the vehicle 400 to promote the use of the travel control mode. Non-limiting examples of the simulation mode may include an actual vehicle simulation mode. Contents of processing in the actual vehicle simulation mode are described later in detail.

In one embodiment of the disclosure, a module including the travel_ECU 190 and the CP_ECU 150 may serve as a “driver assistance apparatus”. In one embodiment of the disclosure, the travel_ECU 190 may serve as a “processor”. In one embodiment of the disclosure, the CP_ECU 150 may serve as a “communicator”.

Next, with reference to FIG. 8, the promotion of the use of the driver assistance system in the vehicle 400 is described. FIG. 8 illustrates an example of a processing procedure necessary for the coaching in the driver assistance system in step S107 in FIG. 3. In the following, each step illustrated in FIG. 8 is described.

For example, first, the travel_ECU 190 may generate the message prompting the driver to park the vehicle 400 and output the message to the CP_ECU 150, to ensure the safety of the vehicle 400 when performing the coaching (step S201). The CP_ECU 150 may output a video signal including the message acquired from the travel_ECU 190 to the center panel display 166 and output an audio signal corresponding to the message to the speaker 167. The center panel display 166 may display a video including the message, and the speaker 167 may output the sound corresponding to the message while the video including the message is displayed on the center panel display 166.

Thereafter, the travel_ECU 190 may monitor an input of a signal indicating that parking of the vehicle 400 has been detected, and continue to determine whether the vehicle 400 has been parked (step S202). At this occasion, let us assume that the driver has parked the vehicle 400 in accordance with the message from the vehicle 400. When the travel_ECU 190 acquires, from the vehicle speed sensor 130, a signal indicating that the speed (vehicle speed) of the vehicle 400 has become zero, the travel_ECU 190 may determine that the parking of the vehicle 400 has been detected (step S202; Y).

The travel_ECU 190 may further determine whether the vehicle 400 has been parked in the predetermined parking lot, based on the signal obtained from the GNSS sensor 120 and the map data obtained from the roadmap DB 140 (step S203). When the vehicle 400 has been parked in the predetermined parking lot (step S203; Y), the travel_ECU 190 may determine that the acquisition of the signal indicating that the vehicle 400 has been parked in the predetermined parking lot is the request for the start of the proposal α2 (coaching in the driver assistance system) as the intention of the user, and perform the processing necessary for the execution of the proposal α2.

In one example, first, the travel_ECU 190 may set the actual vehicle simulation mode as the driving mode (step S213). Thus, it is possible for the travel_ECU 190 to allow the vehicle 400 to execute the response to the driver's operations of the HMI 160 without reflecting the driver's operations of the HMI 160 in the actual travel of the vehicle 400. That is, for example, the driver's operations of, for example, the switch 162, the accelerator pedal 163, or the like, exert no influence on the travel of the vehicle 400.

Thereafter, the travel_ECU 190 may read the video tutorial on the driver assistance system from a storage of the vehicle 400 or a data server in a network, and transmit, or distribute, the video tutorial to the terminal device 200 through the communicator 170 (step S214). The terminal device 200 may play back the video tutorial transmitted, or distributed, from the vehicle 400, or the communicator 170. It is possible for the driver to learn the driver assistance system with the video tutorial played back by the terminal device 200.

The travel_ECU 190 may output the video tutorial on the driver assistance system to the CP_ECU 150. In this case, the CP_ECU 150 may output the video tutorial obtained from the travel_ECU 190, to the center panel display 166. The center panel display 166 may play back the video tutorial, and the speaker 167 may output the sound corresponding to the video tutorial displayed on the center panel display 166.

The travel_ECU 190 may monitor an input of a signal indicating the detection of the operation of the HMI 160 necessary for the use of the driver assistance system, and continue to determine the presence or the absence of the operation of the HMI 160 necessary for the use of the driver assistance system (step S215). At this occasion, let us assume that the driver operates the HMI 160 necessary for the use of the driver assistance system in accordance with the message included in the video tutorial. When the travel_ECU 190 acquires the signal indicating detection of the operation of the HMI 160 (step S215; Y), the travel_ECU 190 may perform the processing necessary for the vehicle 400 to execute the response to the detected operation without reflecting the response in the actual travel of the vehicle 400 (step S216). For example, when the accelerator pedal 163 is operated, the travel_ECU 190 may generate an accelerator sound, with the vehicle 400 parked, without causing the vehicle 400 to travel, and output the accelerator sound to the speaker 167. The speaker 167 may play back the inputted accelerator sound.

At the end of the transmission, or the distribution, of the video tutorial or at the end of the playback of the video tutorial by the terminal device 200, the travel_ECU 190 may perform steps S205 to S208 described above. In this way, the use of the unused driver assistance system is promoted.

Next, effects of the vehicle 400 according to the third embodiment of the disclosure are described.

In the embodiment, upon the acquisition of the refusal of the proposal for the use of the driver assistance system as the response, the proposal for the coaching in the driver assistance system is made. Upon the acquisition of the consent to the proposal for the coaching in the driver assistance system as the response, the processing necessary for the coaching is performed in line with the input of the intention of the user. Hence, it is possible to promote the use of the unused driver assistance system.

In the embodiment, upon the acquisition of the signal indicating that the vehicle 400 has been parked in the predetermined parking lot, the acquisition of such a signal may be determined as the request for the start of the coaching in the driver assistance system as the intention of the user, and the processing necessary for the execution of the coaching in the driver assistance system may be performed. Hence, it is possible to promote the use of the unused driver assistance system while securing the safety of the vehicle 400.

In the embodiment, when the response β2 is the acceptance of the proposal α2, the travel_ECU 190 may determine that the response β2 is the request for the start of the coaching in the driver assistance system as the intention of the user, and perform the processing necessary for the execution of the coaching in the driver assistance system. In such a case as well, it is possible to promote the use of the unused driver assistance system.

In the embodiment, the processing necessary for the distribution of the video for the coaching, or the video tutorial, to the center panel display 166 or the terminal device 200 may be performed. Thus, it is possible for the driver to learn the unused driver assistance system with the video for the coaching, or the video tutorial.

In the embodiment, as the processing necessary for the coaching, when the vehicle 400 is set to the actual vehicle simulation mode and the signal indicating the detection of the operation of the HMI 160 necessary for the use of the driver assistance system is acquired, the processing necessary for the vehicle 400 to execute the response to the detected operation may be performed without reflecting the response in the actual travel of the vehicle 400. Hence, it is possible for the driver to try using the unused driver assistance system with the response represented in the vehicle 400.

In the embodiment, the message prompting the driver to park the vehicle 400 in the predetermined parking lot may be generated. Whether the vehicle 400 has been parked in the predetermined parking lot may be monitored based on the signal obtained from the GNSS sensor 120 and the map data obtained from the roadmap DB 140. Hence, it is possible to promote the use of the unused driver assistance system while securing the safety of the vehicle 400.

In the embodiment, when the proposal α2 (coaching in the driver assistance system) is refused, the processing necessary for the transmission, to the terminal device 200, of the invitation mail to the proposal α2 or the invitation mail to the trial session of the driver assistance system at the dealer may be performed. Continuously transmitting such an invitation mail makes it possible to encourage the driver to be interested in using the unused driver assistance system some time.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

It is to be noted that the effects described in the specification are merely examples. Effects of the disclosure are not limited to the effects described in the specification. The disclosure may produce other effects than described in the specification.

Moreover, for example, the disclosure may take the following configurations.

(1)

A driver assistance apparatus including:
a processor configured to generate request data regarding a request of a user for an input, and process response data to the request data; and
   a communicator configured to transmit the request data to a user interface, and receive the response data from the user interface,
the processor being configured to,
   upon acquisition of data regarding refusal of use of an unused driver assistance system as the response data, generate data regarding a proposal for coaching in the driver assistance system as the request data, and
   upon acquisition of data regarding consent to the coaching in the driver assistance system as the response data, perform processing necessary for the coaching in line with the input of an intention of the user.
      (2)

The driver assistance apparatus according to (1), further including a signal acquirer configured to acquire a vehicle travel signal and a vehicle parking signal, in which
upon sequential acquisition of the vehicle travel signal and the vehicle parking signal in this order through the signal acquirer, the processor is configured to determine that the acquisition of the vehicle parking signal is a request for a start of the coaching as the intention of the user, and perform the processing necessary for the coaching.
   (3)

The driver assistance apparatus according to (1), in which
upon acquisition of a request for a start of the coaching as the response data, the processor is configured to determine that the request for the start of the coaching is the intention of the user and perform the processing necessary for the coaching.
   (4)

The driver assistance apparatus according to any one of (1) to (3), in which as the processing necessary for the coaching, the processor is configured to perform processing necessary for distribution of a video for the coaching to a display of a vehicle or a terminal device of the user.

(5)

The driver assistance apparatus according to (1) or (3), in which
the processor is configured to acquire an operation signal indicating detection of an operation of an in-vehicle device necessary for the use of the driver assistance system, and
as the processing necessary for the coaching, the processor is configured to set a vehicle to a simulation mode, and upon acquisition of the operation signal, perform processing necessary for distribution of a video including a response to the detected operation.
   (6)

The driver assistance apparatus according to (2), in which
the signal acquirer is configured to acquire an operation signal of an operation of an in-vehicle device necessary for the use of the driver assistance system, and
as the processing necessary for the coaching, the processor is configured to set a vehicle to a simulation mode, and upon acquisition of the operation signal through the signal acquirer, perform processing necessary for distribution of a video including a response to the operation of the in-vehicle device.
   (7)

The driver assistance apparatus according to (1) or (3), in which
the processor is configured to acquire an operation signal of an operation of an in-vehicle device necessary for the use of the driver assistance system, and
as the processing necessary for the coaching, the processor is configured to set a vehicle to a simulation mode, and upon acquisition of the operation signal, perform processing necessary for the vehicle to execute a response to the operation of the in-vehicle device.
   (8)

The driver assistance apparatus according to (2), in which
the signal acquirer is configured to acquire an operation signal of an operation of an in-vehicle device necessary for the use of the driver assistance system, and
as the processing necessary for the coaching, the processor is configured to set a vehicle to a simulation mode, and upon acquisition of the operation signal through the signal acquirer, perform processing necessary for the vehicle to execute a response to the operation of the in-vehicle device.
   (9)

The driver assistance apparatus according to (1) or (3), further including a
signal acquirer configured to acquire a positional signal of a vehicle, in which the processor is configured to
upon acquisition of the data regarding the consent to the coaching, generate a message prompting the user to park the vehicle in a predetermined parking lot,
output the message to the user interface through the communicator, and
monitor whether the vehicle has been parked in the predetermined parking lot based on the positional signal acquired through the signal acquirer.
   (10)

The driver assistance apparatus according to (2), in which
the signal acquirer is configured to acquire a positional signal of a vehicle, and
the processor is configured to
   upon acquisition of the data regarding the consent to the coaching, generate a message prompting the user to park the vehicle in a predetermined parking lot,
   output the message to the user interface through the communicator, and
   monitor whether the vehicle has been parked in the predetermined parking lot based on the positional signal acquired through the signal acquirer.
      (11)

The driver assistance apparatus according to any one of (1) to (3), in which
upon acquisition of the data regarding the refusal of the coaching in the driver assistance system as the response data, the processor is configured to perform processing necessary for transmission, to the terminal device of the user of a vehicle, of an invitation mail to the coaching in the driver assistance system or an invitation mail to a trial session of the driver assistance system at a dealer.
   (12)

A vehicle comprising:
a processor configured to generate request data regarding a request of a user for an input, and process response data to the request data; and
a communicator configured to transmit the request data to a user interface, and receive the response data from the user interface,
the processor being configured to,
   upon acquisition of data regarding refusal of use of an unused driver assistance system as the response data, generate data regarding a proposal for coaching in the driver assistance system as the request data, and
   upon acquisition of data regarding consent to the coaching in the driver assistance system as the response data, perform processing necessary for the coaching in line with the input of an intention of the user.

The travel_ECUs 110, 180, and 190 and the CP_ECU 150 illustrated in FIGS. 1, 5, and 7 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the travel_ECUs 110, 180, and 190 and the CP_ECU 150. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the travel_ECUs 110, 180, and 190 and the CP_ECU 150 illustrated in FIGS. 1, 5, and 7.

1. A driver assistance apparatus comprising:
a processor configured to generate request data regarding a request of a user for an input, and process response data to the request data; and
a communicator configured to transmit the request data to a user interface, and receive the response data from the user interface,
the processor being configured to,
upon acquisition of data regarding refusal of use of an unused driver assistance system as the response data, generate data regarding a proposal for coaching in the driver assistance system as the request data, and
upon acquisition of data regarding consent to the coaching in the driver assistance system as the response data, perform processing necessary for the coaching in line with the input of an intention of the user.

2. The driver assistance apparatus according to claim 1, further comprising a signal acquirer configured to acquire a vehicle travel signal and a vehicle parking signal, wherein
the processor is configured to, upon sequential acquisition of the vehicle travel signal and the vehicle parking signal in this order through the signal acquirer, determine that the acquisition of the vehicle parking signal is a request for a start of the coaching as the intention of the user, and perform the processing necessary for the coaching.

3. The driver assistance apparatus according to claim 1, wherein
as the processing necessary for the coaching, the processor is configured to perform processing necessary for distribution of a video for the coaching to a display of a vehicle or a terminal device of the user.

4. The driver assistance apparatus according to claim 2, wherein
as the processing necessary for the coaching, the processor is configured to perform processing necessary for distribution of a video for the coaching to a display of a vehicle or a terminal device of the user.

5. The driver assistance apparatus according to claim 1, wherein
the processor is configured to acquire an operation signal indicating detection of an operation of an in-vehicle device necessary for the use of the driver assistance system, and
as the processing necessary for the coaching, the processor is configured to set a vehicle to a simulation mode, and upon acquisition of the operation signal, perform processing necessary for distribution of a video including a response to the detected operation.

6. A vehicle comprising:
a processor configured to generate request data regarding a request of a user for an input, and process response data to the request data; and
a communicator configured to transmit the request data to a user interface, and receive the response data from the user interface,
the processor being configured to,
upon acquisition of data regarding refusal of use of an unused driver assistance system as the response data, generate data regarding a proposal for coaching in the driver assistance system as the request data, and
upon acquisition of data regarding consent to the coaching in the driver assistance system as the response data, perform processing necessary for the coaching in line with the input of an intention of the user.
